(19) United States
(12) Patent Application Publication
(10) Pub. No.: US 2019/0316368 A1
(43) Pub. Date: Oct. 17, 2019

(54) LARGE MANIPULATOR HAVING A WEIGHT-OPTIMIZED ARTICULATED BOOM

(71) Applicant: SCHWING GMBH, Herne (DE)

(72) Inventors: Murat AKKOC, Dortmund (DE); Mykola OLEKSYUK, Hattingen (DE); Bernd SEGSCHNEIDER, Dortmund (DE)

(73) Assignee: Schwing GmbH, Herne (DE)

(21) Appl. No.: 16/317,297

(22) PCT Filed: Jul. 12, 2017
(86) PCT No.: PCT/EP2017/067562

§ 371 Date: Jan. 11, 2019

(30) Foreign Application Priority Data
Jul. 12, 2016 (DE) 10 2016 112 748.5

(51) Int. Cl. E04G 21/04; B25J 9/10

(52) U.S. Cl. CPC E04G 21/0445; B66C 23/68; B25J 9/106

(57) ABSTRACT

A large manipulator includes a folding-out articulated mast with a turntable rotatable about a vertical axis and with a plurality of mast segments. The mast segments are each pivotable on articulated joints about articulated axes relative to an adjacent mast segment or the turntable. The at least one mast is formed by a hollow structure of wall elements connected with each other. At least one of the wall elements includes a recess region with a recess. A material thickness of the at least one wall in the recess region is less than a material thickness of the at least one wall element outside the recess region.

The invention relates to a large manipulator having a folding-out articulated mast which has a turntable pivotable about a vertical axis and a plurality of mast segments, wherein the mast segments each are pivotable at articulated joints about articulation axes with respect to an adjacent mast segment or the turntable, wherein at least one mast segment is formed by a hollow structure of wall elements connected with each other.

The development of such large manipulators is subject to the necessity of providing ever larger mast lengths because of growing demands, however, the dead weight of the large manipulators limits these attempts.

From the prior art, it is known to provide truss-like structures on the mast segments of the large manipulators in order to reduce the weight. However, these have the disadvantage in that they form an open structure, so that dirt and water can penetrate and water or dirt accumulations form on the surface. In addition, the inner sides of the open mast segments are difficult to check for rust spots, so that weakening of the mast segments by rust is often not detected in a timely manner. Furthermore, solidly buried dirt within the mast segment can lead to increased weight, whereby the strength and stability of the large manipulator are jeopardized.

It is also known from the prior art that the mast segments are composed of sheets of different material thickness, usually decreasing toward the mast top. This is necessary in order to keep the load torque of the mast as low as possible, but requires a plurality of butt joints or welded connections, which are complex in terms of production technology. In addition, greater material thicknesses must be provided, in particular in the region of the mast top, in order to still guarantee the weldability of the material, although from a construction point of view, even lower material thicknesses would be sufficient. As a result, the weight of the mast segments, in particular in the critical region of the mast top, is unnecessarily high from a static point of view.

The object of the invention is therefore to specify a large manipulator which overcomes the disadvantages described and enables easy and safe weight reduction.

This object is achieved by a large manipulator having the features of claim 1.

Due to the fact, that a recess is introduced in at least one of the wall elements, wherein the depth of the recess is less than the material thickness, that is, the wall thickness of the wall element, so that the wall element is closed in the region of the recess, a weight reduction can be achieved in a simple but also safe manner. The closed wall elements continue to provide security against the penetration of water and dirt, wherein the recess, which is introduced into the wall elements, is enables a significant weight reduction.

Advantageous embodiments and modifications of the invention become apparent from the dependent claims.

According to an advantageous embodiment of the invention, it is provided that the recess is arranged on the inner side of the wall element. With the arrangement of the recess on the inner side of the wall element, there can be a prevention of dirt and mud attaching to edges in the edge region of the recess and forming rust spots there due to moisture.

A further advantageous embodiment is that a plurality of recesses are provided on the wall element, which recesses form a truss-like structure with webs and pocket surfaces, wherein the pocket surfaces have at least a reduced material thickness. With multiple recesses forming a truss-like structure, the stability of the mast segment can be maintained although the recesses significantly reduce the weight of the mast segment. Sufficient stability is provided by the webs, which form the truss-like structure together with the pocket surfaces. A significant weight reduction can be achieved in a simple manner through the reduced material thickness of the pocket surfaces. The pocket surfaces can have both a uniform material thickness and a material thickness different from each other. Special design conditions can be taken into account with a different material thickness of the individual pocket surfaces.

A preferred embodiment provides for the webs having the material thickness of the wall element at least in regions. A simple option is provided for producing stable webs of the solid material of the wall elements when the webs have the same thickness as the wall element at least in regions. To further reduce the weight, however, individual webs can also have a lower material thickness.

Particularly advantageous is the development in which the at least one mast segment has a substantially planar outer side. Dirt and water accumulation on the outer surface can be avoided due to the substantially planar outer side of the mast segment. The fact that the mast segment has hardly any edges that could contribute to the formation of rusty spots ensures longevity. In addition, the flat outer surface is easy to clean.

A further advantageous embodiment is that a plurality of recesses is distributed on the wall elements of the mast segment formed as web plates. The arrangement of the recesses on the web plates of the mast segment enables a weight reduction without impairing the stability and strength of the mast segment.

In an advantageous embodiment, the specific surface portion and/or the relative depth of the recesses increase toward the top of the mast segment, that is, in the direction of the mast top. The specific surface portion is to be understood to mean the portion of the resulting surface of the recesses to the surface of the wall element per unit length. The relative depth of a recess is understood to mean the ratio of the depth of the recess to the material thickness of the wall element. By this arrangement or configuration of the recess, the load torque is reduced towards the mast top, without necessarily using metal sheets of different material thickness, so that the number of butt joints can be reduced.

A further advantageous embodiment of the invention provides that at least the last mast segment forming the mast top has recesses. Weight savings, in particular at the last mast segment forming the mast top, also called fliers, enable a weight reduction in the design of the other, previously arranged mast segments of the large manipulator. The other mast segments carrying the mast top can be made lighter with each weight saving at the mast top.

Furthermore, it is advantageous to form the inner edge of the recesses rounded. This shape of the recesses reduces local stress concentrations in the wall elements, so that the risk of cracks is reduced.

The recesses are advantageously formed circumferentially closed. This ensures that the wall elements at the edge regions, at which they are welded to other wall elements, have no recesses which can cause difficulties when welding the wall elements.

Advantageously, the recesses are designed cascade-shaped, that is, a recess is is composed of recesses of different depths, whereby a greater weight saving can be achieved without significant impairment of the rigidity of the mast segment.

The recesses are advantageously introduced by milling out the wall element. The milling-out is a simple type of metalworking and with suitable milling heads, for example, recesses can be introduced with different edge regions in one operation.

In an alternative embodiment, the recesses can also be introduced by etching the wall element. The depth of the recess can be designed very individually with today's known and customary etching techniques.

Alternatively, the recess of the mast segment can also be provided in a wall element made of fiber-reinforced composite materials, which segment consists of a plurality of fiber layers. The recess is simply formed by providing a smaller number of fiber layers in the region of the recess.

Further features, details and advantages of the invention are apparent from the following description and from the drawings. Embodiments of the invention are shown schematically in the following drawings and will be described in more detail below. Shown are:

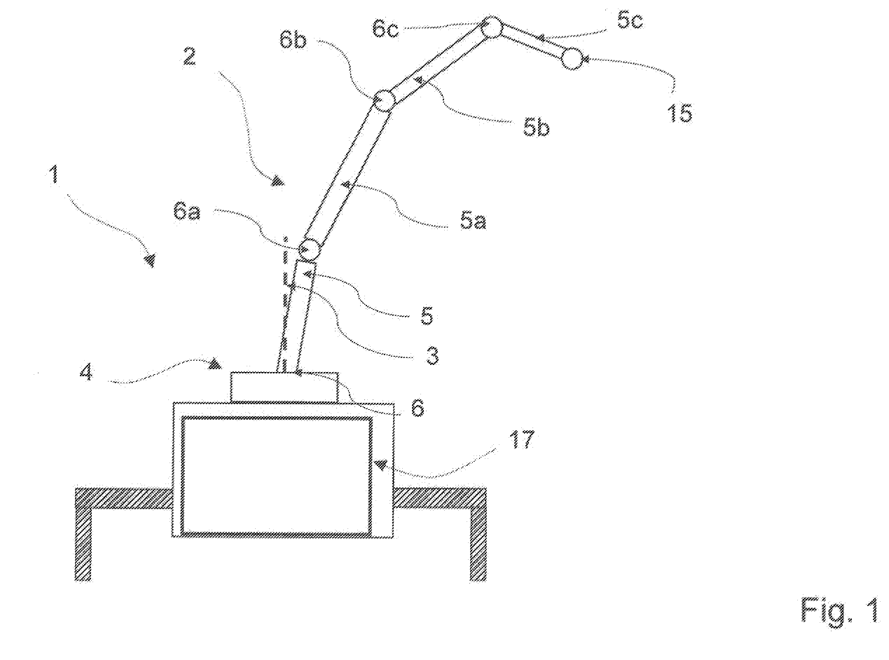

FIG. 1: a schematic representation of a large manipulator according to the invention;

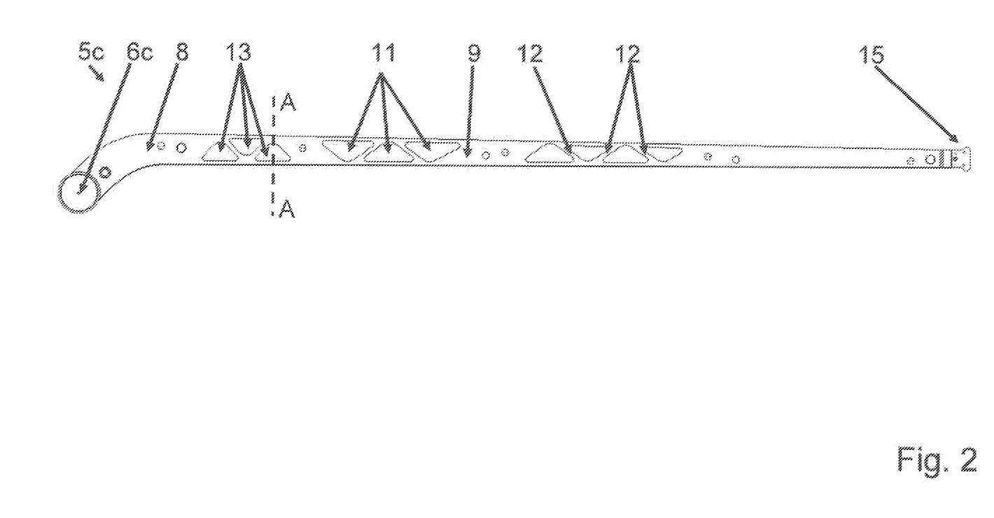

FIG. 2: a schematic representation of a mast segment according to the invention;

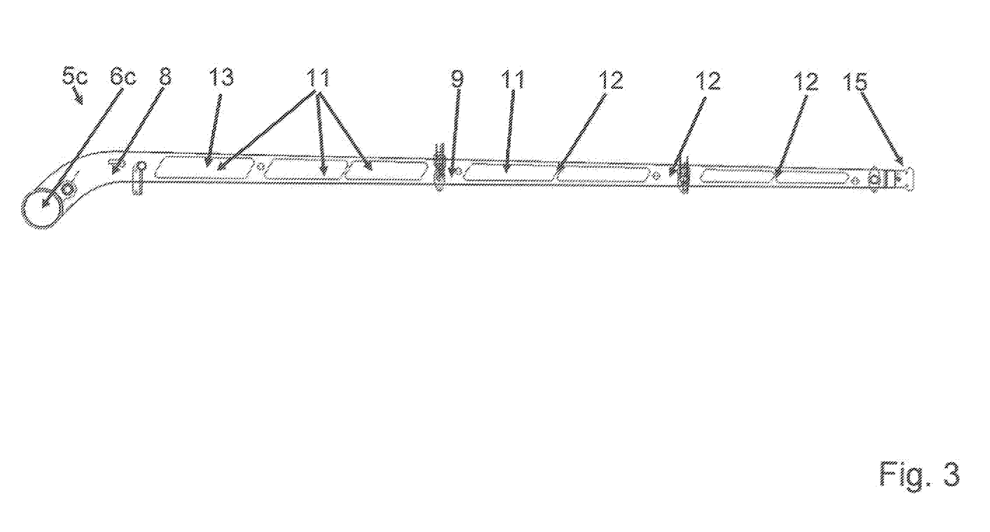

FIG. 3: a schematic representation of a further embodiment of the mast segment according to the invention;

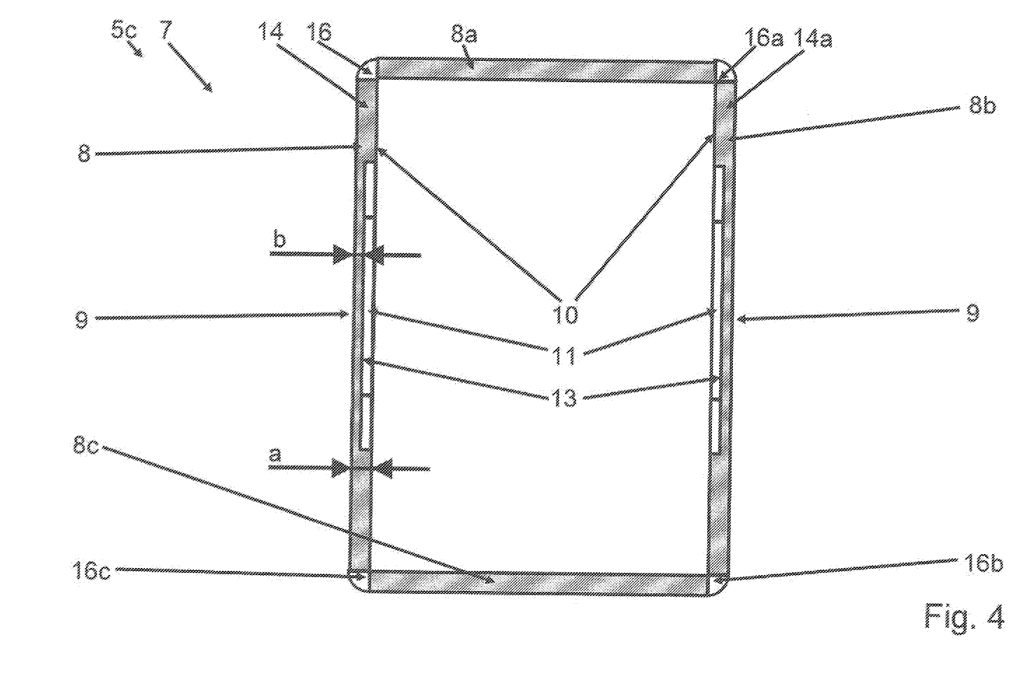

FIG. 4: a schematic sectional representation through a mast segment according to the invention.

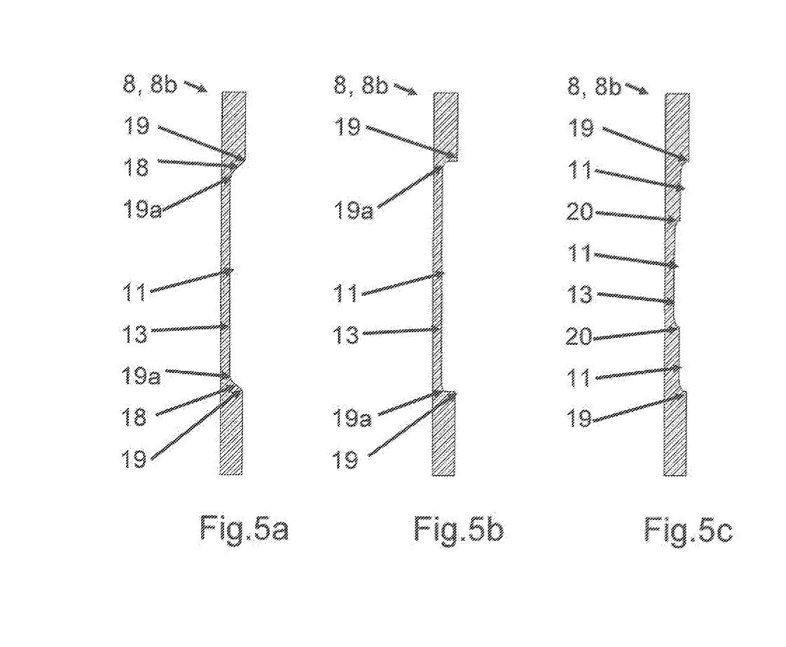

FIG. 5a, 5b, 5c schematic sectional representations through a wall element according to the invention having differently shaped recesses

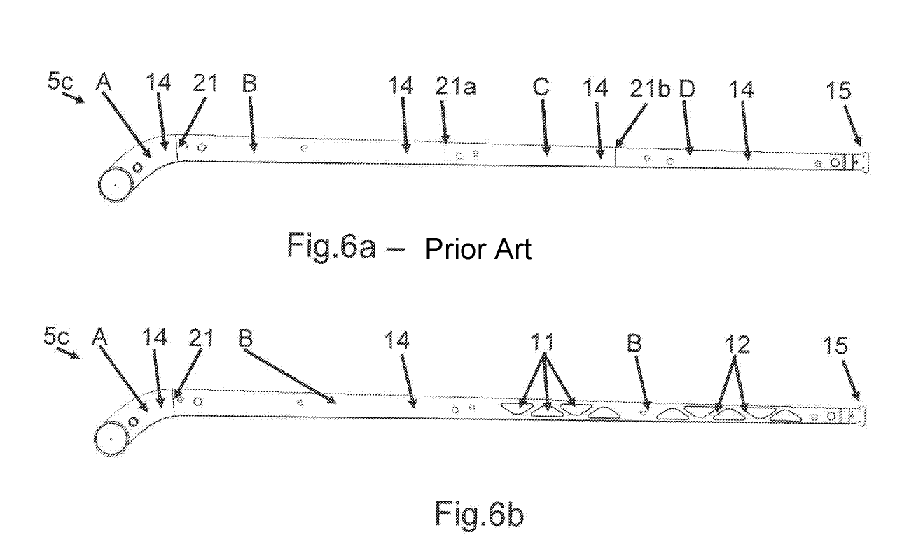

FIG. 6a a schematic representation of a mast segment according to the prior art

FIG. 6b a schematic representation of a further embodiment of the mast segment according to the invention

The representation according to FIG. 1 shows a large manipulator 1 for truck-mounted concrete pumps having folding-out articulated mast 2, which has a turntable 4 rotatable about a vertical axis 3 and a plurality of mast segments 5, 5a, 5b, 5c. The mast segments 5, 5a, 5b, 5c are each pivotable at articulated joints 6, 6a, 6b, 6c about articulation axes relative to an adjacent mast segment 5, 5a, 5b, 5c or the turntable 4 by means of in each case one drive unit (not shown). The fluid concrete is transported from the concrete pump 17 to the mast top 15 via concrete supply lines (not shown) with the aid of the large manipulator 1, where the concrete supply line ends in an end hose (not shown), so that long distances and heights can be bridged with the aid of the large manipulator 1 when concreting with such a truck-mounted concrete pump.

FIG. 2 schematically shows the last mast segment 5c forming the mast top 15 having recesses 11 in the lateral wall element 8. Specifically on this mast segment 5c, the recesses 11 have a particularly advantageous effect, since any weight reduction on this mast segment 5c enables a weight reduction in the design of the other arranged mast segments 5, 5a, 5b (FIG. 1) arranged in front of it, of the large manipulator 1. The recesses 11 are also possible and advantageously also provided there on the other mast segments 5, 5a, 5b. A plurality of recesses 11 are introduced in the wall element 8, wherein the depth of the recesses 11 is less than the material thickness of the wall element 8, so that the wall element 8 is closed in the region of the recesses 11. Therefore, the recesses 11 shown in FIGS. 2 and 3 are only indicated and not visible from the outside according to is the invention. The outer side 9 of the mast segment 5c is designed essentially planar. As a result, dirt and moisture can not hold on edges on the outside 9. The formation of rust can also be effectively avoided through the lack of edges on the outside 9. The configuration of the recesses 11 is also clear from the sectional view according to FIG. 4 by the marked sectional plane A-A. The mast segment 5c has a plurality of recesses 11 on the wall element 8, which form a truss-like structure with webs 12 and pocket surfaces 13. In this case, the pocket surfaces 13 have a reduced material thickness, while the webs 12 have the material thickness of the wall element 8. The webs 12, for example, as shown, are formed in triangle configuration to ensure stability, that is, the webs 12 each include a triangular pocket surface 13 and recess 11. The triangular pocket surfaces 13 are expediently rounded in the corners in order to reduce stress concentrations in the corners of the recesses 11.

FIG. 3 schematically shows another embodiment of a mast segment 5c according to the invention. The pocket surfaces 13 of the recesses 11 here have a different shape than in FIG. 2 and are designed parallelogram-shaped, wherein the pocket surfaces 13 and webs 12 formed by the recesses 11 continue to form a truss-like structure.

It should be noted that in both embodiments, in both FIGS. 2 and 3, advantageously no recesses 11 are provided in the region of weld seams 16, 16a, 16b, 16c (FIG. 4). In addition, no recesses 11 are arranged in the region of the articulated joints 6, 6a, 6b, 6c. Also, no recesses 11 are arranged at the hinge points for the drive units in order not to weaken the mast segment 5c at these locations.

The recesses 11 can alternatively also be designed, for example, round, rectangular, trapezoidal or triangular. Advantageously, a circumferentially closed shape is selected for the recesses 11, so that the recesses 11, as described above, can be arranged such that no recesses 11 are provided in the region of the weld seams 16, 16a, 16b, 16c.

FIG. 4 schematically shows a sectional representation through the sectional plane A-A according to FIG. 2. This sectional representation is intended to explain the design of the recesses 11 (FIGS. 2 and 3) in more detail. As can be seen, the mast segment 5c forms a hollow, box-shaped structure of wall elements 8, 8a, 8b, 8c connected to each other. The wall elements 8, 8a, 8b, 8c are connected to each another via weld seams 16, 16a, 16b, 16c. The recesses 11 introduced into the lateral web plates 14, 14a leave out the region of the weld seams 16, 16a, 16b, 16c, so that the weldability of the wall elements 8, 8a, 8b, 8c is not impaired by the recesses 11. The recesses 11 are introduced on the inner side 10 of the wall elements 8, 8b and have a depth which is less than the material thickness of the wall elements 8, 8b. It can be seen that the wall elements 8, 8b are closed in the region of the recesses 11. As a result, the recesses 11 reduce the material thickness of the wall elements 8, 8b, so that they have a reduced material thickness b in the region of the pocket surfaces 13. The outer sides 9 of the mast segment 5c, that is, its external surfaces, are formed substantially planar. In the exemplary embodiment illustrated in FIG. 4, only the lateral wall elements 8, 8b of the mast segment 5c formed as web plates 14, 14a have recesses 11. The material thickness b in the region of the recesses 11 is preferably about 1 mm in order to still ensure sufficient strength, for example, against impacts on the mast segment 5c. With a material thickness a of, for example, 3 mm on the last mast segment 5c, this results in a reduction of the material thickness, and thus of the weight in the region of the recesses 11, of the order of magnitude of approximately 70%. In the case of metal sheets with a greater material thickness, it is even possible to achieve a reduction in material thickness of 90% and more in the region of the recesses 11.

FIGS. 5a, 5b and 5c show sectional representations of a wall element 8, 8b according to the invention having different configurations of the recess 11. In FIG. 5a, the edge region of the recess 11 is provided with a chamfer 18 and the upper edge 19 and the lower or inner edge 19a of the recess 11 is rounded. This shape of the edges 19, 19a and the chamfer 18 is particularly advantageous with regard to the reduction of local stress concentrations, but more complex in terms of production technology.

In the embodiment of the edge region of the recess 11 according to FIG. 5b, only a rounding is provided on the lower or inner edge 19a of the recess 11. By this measure, the stresses in the edge region of the recess 11 are already significantly reduced relative to an angular transition. Advantageously, the radius of the rounding is in the range of 30-100% of the sheet thickness.

FIG. 5c shows a further variant in which the recess 11 is formed in a cascade shape, that is, terraced by at least one step 20, which offers further possibilities for reducing the weight of the mast segments 5, 5a, 5b, 5c while maintaining high rigidity.

FIG. 6a shows a schematic side view of a mast segment 5c according to the prior art. This figure shows a laterally arranged web plate 14 which is composed of metal sheets of different material thickness. In the region A, the web plate has, for example, a material thickness of 8 mm, in the region B 5 mm, in the region C 4 mm and in the region D 3 mm. The metal sheets of the regions A, B, C and D are connected to each other by butt joints 21, 21a, 21b or weld seams 21, 21a, 21b. Further (not shown) recesses 11 may be mounted in the region of the linkages to reinforce the mast segment 5c at these points.

FIG. 6b shows an advantageous arrangement of the recesses 11, in which the specific surface portion of the recesses 11 increases toward the top of the mast segment, that is, in the direction of the mast top 15. The number of sheets having different material thicknesses and the number of butt joints 21, 21a, 21b are reduced by this measure. This is achieved by, as shown here, for example, using only two sheets having the material thicknesses 8 mm (region A) and 5 mm (region B) and increasing the number of recesses 11 toward the mast top 15. This ensures that the specific weight of the web plate 14 decreases towards the mast top 15 and at the same time, the number of butt joints 21 is reduced, because in the example according to FIG. 6b, only one butt joint 21 between the sections A and B is necessary. Similarly, with a uniform distribution, but increasing area of the individual recesses 11 toward the mast top 15, a weight loss in the direction of the mast top 15 can be realized. A comparable advantage can indeed be achieved by arranging the recesses 11 evenly over the length of the web plate 14, but increasing the relative depth of the recesses 11 towards the mast top 15.

The above considerations on the use of recesses 11 in the region of the web plates 14 apply in the same way also for the wall elements 8a, 8c, formed as a is flange plate, arranged above and below on the mast segments 5, 5a, 5b, 5c.

The recesses 11 can be introduced, for example, by milling out the solid material of the wall element 8, 8a, 8b, 8c into the wall element 8, 8a, 8b, 8c, that is, the recesses 11 are formed as milled-out portions. By milling out, with today's technology, the material thickness of the wall element 8, 8a, 8b, 8c of the flier can be variably reduced from 3 mm to 1-2 mm, whereby a considerable weight saving is achieved. With suitable milling heads, which are laterally chamfered or rounded, in particular, the chamfers and/or roundings of the edge region of the recess 11 described above can be realized in one operation.

As an alternative to milling out, it is, for example, advisable to introduce the recess 11 into the wall element 8, 8a, 8b, 8c by etching. To prepare the etching process, a material, for example, a lacquer, which is resistant to the etching liquid is initially applied to the wall element 8, 8a, 8b, 8c in the regions in which no recess 11 is to be formed. After that, the wall element 8, 8a, 8b, 8c is immersed in an etching liquid until the desired depth of the recess 11 is reached. A stepped recess 11, as described above, can be easily created in several operations with this method.

Further alternatively, a recess 11 can also be introduced into the wall element 8, 8a, 8b, 8c by laser ablation, sand blasting, cold or hot forming (that is, pressing or forging) or other suitable methods.

In principle, it is also possible to use a wall element 8, 8a, 8b, 8c whose wall thickness initially corresponds to the thickness of the intended recess 11. The webs and edge regions described above can be created by welding on material, which ultimately results in the recess 11 in the wall element 8, 8a, 8b, 8c.

Likewise, the production of a wall element 8, 8a, 8b, 8c having a recess 11 is possible in the 3D printing method.

The recesses 11 can advantageously be used not only for mast segments 8, 8a, 8b, 8c made of steel or other metallic materials, but also, for example, for mast segments made of fiber-reinforced plastics, as used, for example, in truck-mounted concrete pumps having so-called carbon masts. A fiber-reinforced plastic (or also fiber-plastic composite or fiber composite plastic) is a material is consisting of reinforcing fibers and a plastic matrix. The matrix surrounds the fibers which are bonded to the matrix by adhesive or cohesive forces.

For the production of a wall element 8, 8a, 8b, 8c made of fiber-reinforced plastic, a plurality of thin, woven mats (approximately 10-50 layers) of reinforcing fibers are commonly superimposed. To form the recesses (11), it is basically sufficient to provide a smaller number of layers of reinforcing fibers in the region of the recesses 11. By a clever choice of the basic thickness of the wall elements, which is determined by the number of layers applied and the depth of the recesses 11, in particular in conjunction with the above-described advantageous, for example, truss-like arrangements of the recesses 11, not inconsiderable weight savings can be realized also with such masts. In particular, in the above-described truss-like structure of the wall elements having a plurality of recesses 11 and the intermediate webs 12, it is particularly advantageous to align the fibers for the webs 12 parallel to the longitudinal direction of the webs 12, so that the webs 12 can optimally absorb the introduced forces.

### LIST OF REFERENCE CHARACTERS

1 large manipulator
2 articulated mast
3 vertical axis
4 turntable
5 5a, 5b, 5c mast segments
6 6a, 6b, 6c articulated joints
7 hollow structure
8 8a, 8b, 8c wall elements
9 outer side
10 inner side
11 recesses
12 web
13 pocket surfaces
14 14a web plate
15 mast top
16 16a, 16b, 16c weld seams
17 concrete pump
18 chamfer
19 19a edge
20 step
21 21a, 21b butt joints
a regular material thickness
b reduced material thickness
A, B, C, D sheet metal regions

1-14. (canceled)

15. A large manipulator comprising:
a folding-out articulated mast with a turntable rotatable about a vertical axis and with a plurality of mast segments, the mast segments are each pivotable on articulated joints about articulated axes relative to an adjacent mast segment or the turntable,
wherein at least one mast is formed by a hollow structure of wall elements connected with each other,
wherein at least one of the wall elements includes a recess region with a recess,
wherein a material thickness of the at least one wall in the recess region is less than a material thickness of the at least one wall element outside the recess region such that the at least one wall element is closed in the recess region.

16. The large manipulator according to claim 15, wherein the recess is arranged on an inner side of the wall element.

17. The large manipulator according to claim 15, wherein the at least one wall element includes a plurality of recesses to form a truss-like structure with webs and pocket surfaces, wherein the pocket surfaces have a reduced material thickness compared to the webs.

18. The large manipulator according to claim 17, wherein the webs have the same material thickness as the material thickness of the at least one wall element outside the recess region.

19. The large manipulator according to claim 15, wherein the at least one mast segment has a substantially planar outer side.

20. The large manipulator according to claim 15, wherein the at least one wall element includes a plurality of recesses of the mast segment formed as web plates.

21. The large manipulator according to claim 15, wherein a surface portion and/or a relative depth of the recess increases toward a top of the at least one mast segment.

22. The large manipulator according to claim 15, wherein a last of the plurality of mast segments is a mast top and includes recesses.

23. The large manipulator according to claim 15, wherein inner edges of the recess are rounded.

24. The large manipulator according to claim 15, wherein the recess is circumferentially closed.

25. The large manipulator according to claim 15, wherein the at least one wall element includes a plurality of recesses arranged in cascade form.

26. The large manipulator according to claim 15, wherein the recess is a milled recess.

27. The large manipulator according to claim 15, wherein the recess is an etched recess.

28. The large manipulator according to claim 15, wherein the at least one wall element comprises a fiber-reinforced composite material with a plurality of fiber layers, wherein the recess region comprises fewer fiber layers compared to a number of fiber layers in the wall element outside the recess region.

29. The large manipulator according to claim 15,
wherein the at least one wall element includes a plurality of recesses that form webs and pocket surfaces, the webs extending along a longitudinal direction,
wherein the at least one wall element comprises a fiber-reinforced composite material with a plurality of fibers,
wherein the plurality of fibers forming the webs are aligned parallel to the longitudinal direction of the webs.

30. The large manipulator according to claim 15, wherein the material thickness of the at least one wall in the recess region is about 1 mm.

31. The large manipulator according to claim 29, wherein the material thickness of the at least one wall outside the recess region is 3 mm.
